(19) United States
(12) Patent Application Publication
(10) Pub. No.: US 2015/0090487 A1
(43) Pub. Date: Apr. 2, 2015

(54) CABLE FOR POWERING OF MAST MOUNTED RADIO EQUIPMENT

(71) Applicant: TELEFONAKTIEBOLAGET L M ERICSSON (PUBL), Stockholm (SE)

(72) Inventor: Lars Efraimsson, Falun (SE)

(21) Appl. No.: 14/402,364

(22) PCT Filed: May 14, 2013
(86) PCT No.: PCT/SE2013/050533

§ 371 Date: Nov. 20, 2014

Related U.S. Application Data
(60) Provisional application No. 61/650,129, filed on May 22, 2012.

(51) Int. Cl. H01B 9/02; H01B 9/00

(52) U.S. Cl. CPC H01B 9/02; H01B 9/003
USPC 174/45 R

(57) ABSTRACT

A cable for powering of radio equipment mounted on a mast for carrying the radio equipment is disclosed. The cable comprises a first conductor for feeding a current to the radio equipment, a return and shielding conductor for feeding a return current from the radio equipment and for shielding of the first conductor, and an insulating material disposed between the first conductor and the return and shielding conductor. The first conductor is at least partially enclosed by the insulating material. A first cross-sectional area of the first conductor is less than a second cross-sectional area of the return and shielding conductor.

### TECHNICAL FIELD

Embodiments herein relate to the field of telecommunications. In particular, a cable for powering of mast mounted equipment and an arrangement comprising one or more such cables are disclosed.

### BACKGROUND

In telecommunication systems, many Radio Remote Units (RRUs) are often operated in a coordinated manner. Therefore, the RRUs are often connected to a radio control equipment that is common for the RRUs connected thereto. In order for the RRUs to be able to transmit and receive radio signals, they can be powered from the radio control equipment by means of a cable.

In Direct Current (DC) and Alternating Current (AC) power applications it is useful to have a low inductance transmission line, such as a cable with low inductance. This gives lower voltage fluctuations, especially for higher frequencies and fast transients of the load current. Also when a fault occurs it will be safer and easier for the fuse to cut out the power line quick.

A known cable for powering of RRUs comprises a first and a second flat conductor and a shielding enclosing the first and second flat conductors. Each of the first and second flat conductors comprises three parallel conductors forming the corresponding one of the first and second flat conductors. The first flat conductor is arranged to feed the RRU with power and the second flat conductor is arranged to conduct a return current to the radio control equipment. For example, article number TFL 492 32, RLAFH Spec, is a cable of this kind. This cable is available on the market. The cable according to TFL 492 32 is designed to have a low inductance. The cable is halogen free, shielded and flexible. Furthermore, the cable is adapted for use in telecom equipment where there are requirements for low inductance and good temperature resistance. The cable is suitable in areas that require high electromagnetic compatibility.

Even though this above mentioned cable is well-functioning, common-mode behavior of the cable is still a limitation in many scenarios. For example, when a stroke of lightning hits one of the RRUs significant amounts of current is fed towards the radio control equipment which needs to be protected from damage due to the current, originating from the stroke of lightning.

In FIG. 1, a block diagram illustrating a RRU 10 connected by a cable to a DC power source is shown. Surge Protective Device (SPD) is a kind of over-voltage protection that is intended to protect the Radio Base Station (RBS) in case of high currents/voltages that may occur when a stroke of lightning hits the RRU, e.g. the antenna thereof. The cable in this example is a two-wire cable having two conductors. Decoupling in this example is 1 mH. A return 11, or sometimes FE, is a DC power cable of less than 25 meters. A generator 13 is specified according to 10/350 microseconds, 8/20 microseconds current impulse.

FIG. 2 shows a block diagram illustrating another exemplifying known set up for powering of a RRU with shielded DC cable. In this example, the RRU is powered via a three-wire cable. Also, in this Figure an SPD for protection is illustrated.

In some scenarios, ripple current and ripple voltage occurs. The ripple current occurs when the antennas receive, or listen, and transmit. The power consumption when the RRU transmits is several times higher than when the RRU receives. This induces a current ripple on the cable, also referred to as a power feeding line. In FIG. 3, ripple current and voltage investigation between a main and remote unit is illustrated. The 15 m cable is specified for 30 μH and the 100 m cable is specified as 10 mm², 40 μH, 30 μH SPD Main unit and 30 μH SPD RRU. RRU-cable is thus at 0.4Ω (from 100 m 10 mm²).

### SUMMARY

An object is to further reduce impedance in the cable of the above mentioned kind.

This object is achieved by designing a cable for powering mast mounted equipment, for example a power coaxial power feeding system, with lower inductance than power cables known in the art. Thanks to the lower inductance, the cable for feeding power to the mast mounted equipment, such as RRUs, can be longer than the power cables known in the art. Hence, increasing flexibility for a location, or placement, of the mast mounted equipment with respect to a power system connected to the cable. The power system may thus feed power, for example over a longer distance than in prior art, to the mast mounted equipment.

According to an aspect, the object is achieved by a cable for powering of radio equipment mounted on a mast for carrying the radio equipment. The radio equipment may comprise one or more of a transmitter, a receiver and an antenna. As an example, the radio equipment may be a RRU or other mast mounted equipment.

The cable comprises a first conductor for feeding a current to the radio equipment, a return and shielding conductor for feeding a return current from the radio equipment and for shielding of the first conductor.

Moreover, the cable comprises an insulating material disposed between the first conductor and the return and shielding conductor. The first conductor is at least partially enclosed by the insulating material.

A first cross-sectional area of the first conductor is less than a second cross-sectional area of the return and shielding conductor. In this manner, a stroke of lightning, when hitting the radio equipment, will be feed in the return and shielding conductor mainly. Expressed differently, the second cross-sectional area of the second conductor is greater than the first cross-sectional area of the first conductor. As an example, the first cross-sectional area may be 6 mm2 and the second cross-sectional area may be 10 mm2.

As an example, a first value of the first cross-sectional area of the first conductor is less than a second value of the second cross-sectional area of the return and shielding conductor. This means that the first value is smaller than the second value.

According to another aspect, the object is achieved by a cable arrangement, such as a multi-craft cable, hybrid cable or the like. The cable arrangement comprises a jacket enclosing two or more cables according embodiments herein.

In some first embodiments, the return and shielding conductor is a second conductor for feeding of the return current and for shielding of the first conductor. As an example, this means that the cable only, in terms of conductors described herein, consists of the first conductor and the second conductor, wherein each of the first and second conductors may comprises a plurality of wires or the like. These embodiments may herein be referred to as two-wire systems.

In some second embodiments, the return and shielding conductor comprises a second conductor for feeding of the return current and a third conductor for shielding of the first conductor. As an example, this means that the cable comprises a separate conductor for return current, i.e. the second conductor. In this example, both the second and third conductor may act as shielding of the first conductor. These embodiments may herein be referred to as three-wire systems.

Therefore, in the first embodiments, the cable comprises a first conductor, a second conductor and an insulating material disposed between the first and second conductors.

The return and shielding conductor may at least partially enclose the first conductor and the insulating material. In the first embodiments, this means that the second conductor may at least partially enclose the first conductor and the insulating material. In an example of the second embodiments, this means that the second conductor may at least partially enclose the first conductor and the insulating material.

The first conductor comprises a first set of conductors and/or the return and shielding conductor comprises a second set of conductors. In the first embodiments, this means that the first conductor comprises a first set of conductors and/or the second conductor comprises a second set of conductors. In an example of the second embodiments, this means that the first conductor comprises a first set of conductors and/or the second conductor comprises a second set of conductors.

The first conductor may have the shape of an elongated cylinder, whose length is greater than a radius thereof.

The return and shielding conductor may have the shape of one or more elongated cylinders, each of which having a length which is greater than a radius thereof. In the first embodiments, this means that the second conductor may have the shape of one or more elongated cylinders, each of which having a length which is greater than a radius thereof. In an example of the second embodiments, this means that the second conductor may have the shape of one or more elongated cylinders, each of which having a length which is greater than a radius thereof.

The return and shielding conductor may be enclosed by an insulating layer. In the first embodiments, this means that the second conductor may be enclosed by the insulating layer. As an example of the second embodiments, this means that the second conductor may be enclosed by the insulating layer.

The first conductor may comprise a first set of conductors. The second conductor may comprise a second set of conductors.

The first conductor may have the shape of an elongated cylinder, whose length is greater than, typically much greater than, a radius thereof. As an example, the first conductor may comprise one or more wires.

The return and shielding conductor may have the shape of one or more elongated cylinders, each of which having a length which is greater than, typically much greater than, a radius thereof. In the first embodiments, the return and shielding conductor is the second conductor. When there is one elongated cylinder, the elongated cylinder may have a cavity for receiving the insulating material and the first conductor. As an example, the second conductor may comprise one or more wires.

In the second embodiments, the second conductor may comprise a first group of conductors for return current. The conductors of the first group may be are arranged at the periphery of the cable. One or more of the conductors of the first group may be enclosed by a respective first insulating layer.

In the second embodiments, the third conductor may comprise a second group of conductors for shielding of the first conductor and/or the second conductor. The conductors of the second group may be arranged at the periphery of the cable. One or more of the conductors of the second group may be enclosed by a respective second insulating layer. At least one of the second and third conductors may be is located such as to at least partially enclose the first conductor.

In the second embodiments, the cable may have a longitudinal geometrical axis, wherein at least one of the second conductor and the third conductor is located to at least partially enclose the first conductor, wherein at least one of the second and third conductors is spaced apart from the first conductor by means of the insulating material and/or, when applicable according to embodiment, the insulating layer.

In the second embodiments, the second conductor may be formed as an elongated cylinder having a cavity for receiving the insulating material and/or the first conductor, wherein the third conductor is formed as an elongated cylinder having a cavity for receiving the insulating layer and/or the second conductor.

Further exemplifying embodiments are described in the following.

The second conductor may be enclosed by an insulating layer.

The second conductor may be for feeding of return current and/or for shielding of the first conductor.

In some embodiments, the second conductor may be utilized for feeding return current. In these embodiments, the cable may comprise a third conductor for shielding of the first conductor as well as the second conductor. In some examples, the second conductor may comprise a first group of conductors, such as wires, for return current. In some examples, the third conductor may comprise a second group of conductors, such as wires, for shielding of the first conductor and/or the second conductor.

It may be preferred that the second and/or third conductor is/are located or formed such as to at least partially enclose the first conductor according to the second embodiments.

As an example according to the second embodiments, the cable has a longitudinal geometrical axis. The second and/or third conductors may be located to at least partially enclose the first conductor. The second and/or third conductor is spaced apart from the longitudinal geometrical axis (i.e. the first conductor) by means of the insulating material and/or the insulating layer. The less the second and/or third conductor and the first conductor are spaced apart, the smaller inductance of the cable.

In the second embodiments, the second conductor may be formed as an elongated cylinder having a cavity for receiving the insulating material and/or the first conductor. The third conductor may be formed as an elongated cylinder having a cavity for receiving the insulating layer and/or the second conductor. Thus, the cable may, as an example, be a coaxial cable.

As an alternative (or in addition to), when the second conductor comprises the first group of wires, the wires of the first group may be arranged at the periphery of the cable. Similarly, when the third conductor comprises the second group of wires, the wires of the second group may be arranged at the periphery of the cable. At the periphery of the cable (for the first and/or second group of wires) may be distally from the geometrical longitudinal geometrical axis.

One or more of the wires of the first group may be enclosed by a respective first insulating layer. One or more of the wires of the second group may be enclosed by a respective second insulating layer.

According to embodiments herein, a stroke of lightning will mainly go on the outer conductor (or conductors), i.e. the second and/or third conductors. This reduces the current in the first conductor, such as a main conductor, 15% to 50% for long current strikes, e.g. 10/350 pulses, depending on the design, according to embodiments herein, with the same amount of copper in second conductor, such as a return conductor, and third conductor, such as a shield, or screen, conductor, as compared to conventional and existing designs of cables of the types initially mentioned.

In some embodiments, this gives the possibility to reduce the diameter of cable. Moreover, the cable according to embodiments herein is easier to handle and install. For example, the cable may be more compact when the cable is formed as a coaxial cable with a first and second conductor. The weight of cable also is an important parameter in these installations. This construction can also be more cost effective, due to that less material is needed.

Lower inductance may also be achieved. Thanks to lower inductance and less time fluctuating current in DC feeding smaller fluctuations in voltage may be achieved. This gives that the smaller cupper conductors can be used for longer feedings with the same voltage drop.

Another benefit is to have a geometry of the conductors that reduces the current in the spectrum of frequencies that lightning pulses have in the main conductor. That means that the main conductor has a higher impedance compared to the return or/and ground conductor in the lightning spectrum than in power cables known in the art.

A further advantage is that the cable has a geometry of the second conductor, and possibly also the third conductor, that gives low impedance for the spectrum of frequencies that lightning pulses have. Therefore, a lower current in the first conductor when strokes of lightning hit the radio equipment will be generated. Additionally, voltage variation in the cable on loads with current transients is reduced.

### BRIEF DESCRIPTION OF THE DRAWINGS

The various aspects of embodiments disclosed herein, including particular features and advantages thereof, will be readily understood from the following detailed description and the accompanying drawings, in which:

FIG. 1 shows a schematic overview of an exemplifying known Radio Remote Unit connected to a power source,

FIG. 2 shows another schematic overview of an exemplifying known Radio Remote Unit connected to a power source,

FIG. 3 is a further schematic overview of an exemplifying known Radio Remote Unit connected to a power source,

FIG. 4 is a schematic overview of an exemplifying Radio Remote Unit according to embodiments herein,

FIGS. 5-7 illustrate exemplifying cables according to embodiments herein,

FIGS. 8-9 illustrate impulse test diagrams for embodiments herein,

FIGS. 10-11 illustrate an exemplifying cable according to embodiments herein,

FIG. 12 illustrates a diagram in which current is plotted versus frequency for different cables,

FIGS. 13-22 illustrate exemplifying cables according to embodiments herein,

FIG. 23 illustrates inductive voltage drop in a diagram, and

FIGS. 24-27 illustrate exemplifying sites at which the cable according to embodiments herein may be used.

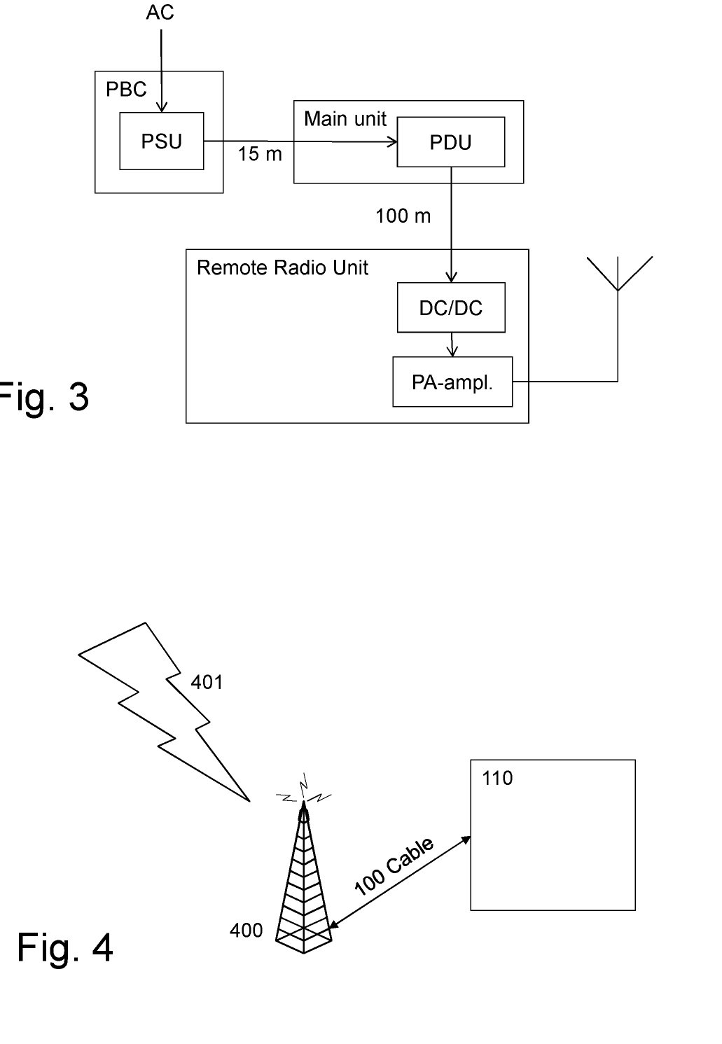

FIG. 4 is a schematic block diagram illustrating an exemplifying network node configured to perform the methods illustrated in FIG. 2 and/or 3.

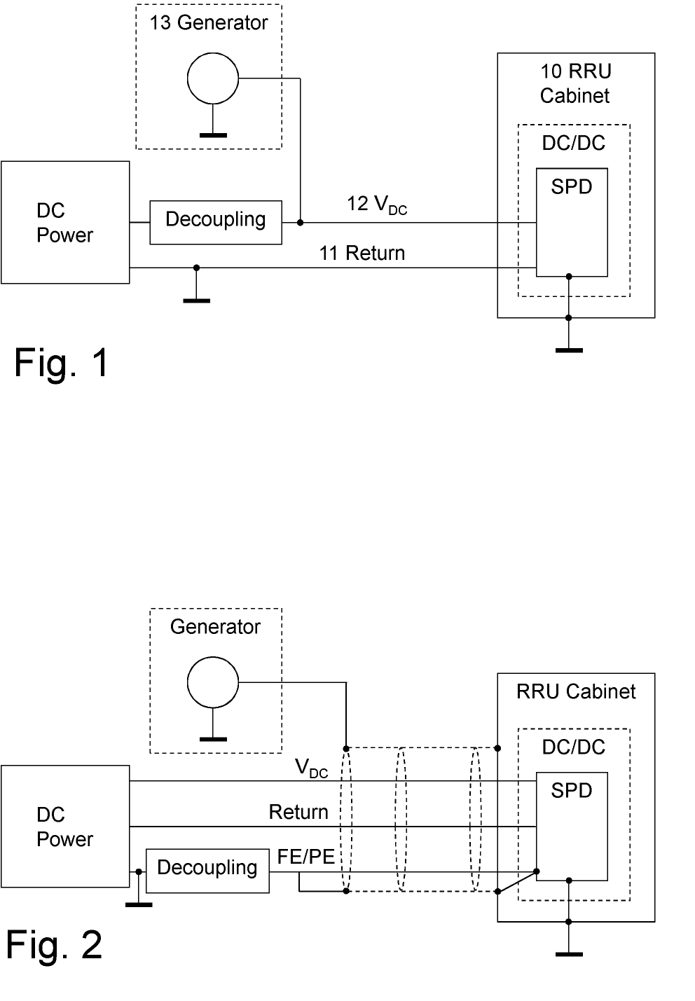

FIG. 1 is a schematic block diagram illustrating embodiments in an exemplifying wireless communication system,

FIG. 3 is a combined signaling scheme and flowchart illustrating embodiments of the methods,

FIG. 9 is a flowchart illustrating embodiments of the method in the radio network node, and

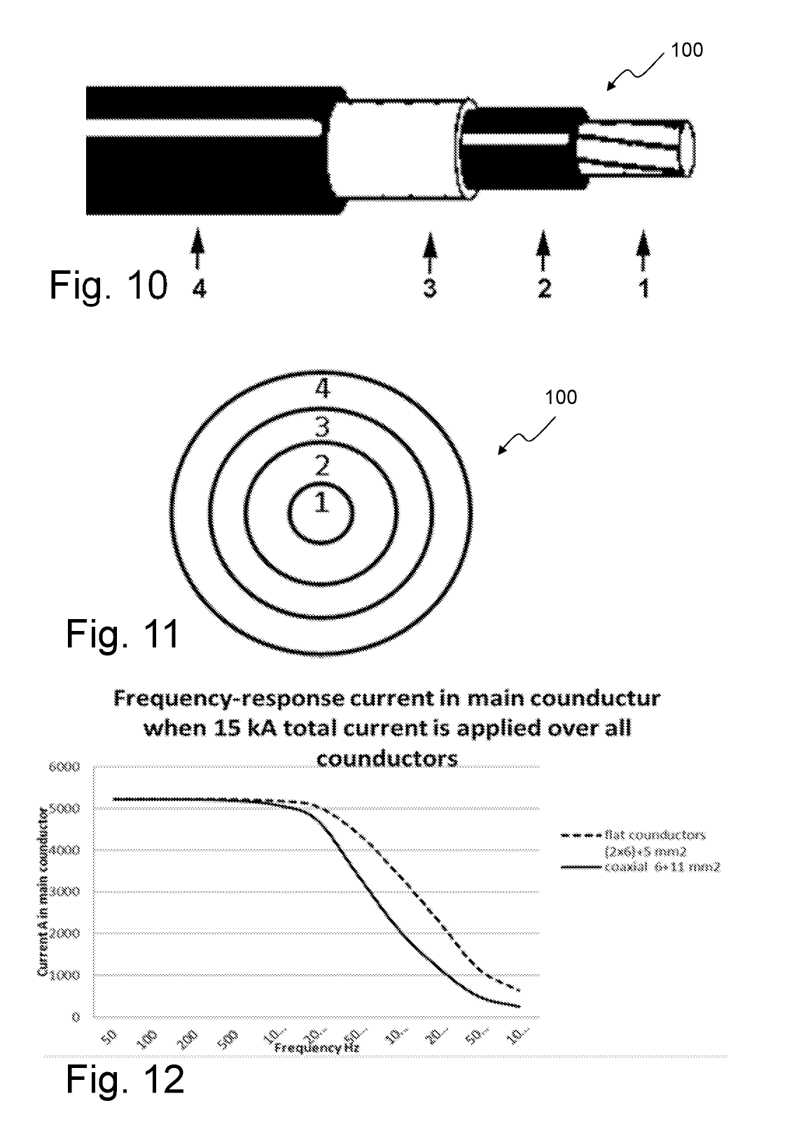

FIG. 10 is another block diagram illustrating embodiments of the radio network node.

### DETAILED DESCRIPTION

Throughout the following description similar reference numerals have been used to denote similar elements, network nodes, parts, items or features, when applicable. In the Figures, features that appear in some embodiments are indicated by dashed lines.

FIG. 4 is an overview, illustrating a Radio Remote Unit (RRU) 400 that is hit by a stroke of lightning 401. The RRU 400 is connected to a radio control equipment 110 that may be located indoors or outdoors. The radio control equipment 110 may be a radio base station, a base station unit or the like. The radio control equipment 110 controls transmission and/or reception of signals at the radio equipment.

Power cables with low inductance, and generally low impedance, are required for DC power distribution with fast transients in current in the powered unit.

In this description at least two embodiments are presented:

1) A shielded coaxial cable, e.g. a triax cable, and

2) a shielded pair cable with separate ground conductors.

The shielded coaxial cable has better electrical performance than the shielded pair cable, but the shielded coaxial cable has disadvantages in handling. The shielded pair cable is cheap and easy to handle. However, the shielded pair cable has an inductance 2-4 times higher than the shielded coaxial cable (depending on design/construction of the shielded pair cable).

According to embodiments herein, a stroke of lightning will mainly go on the outer conductor (or conductors). This reduces the current in the main conductor 15% to 50% for long current strikes, such as 10/350 pulses, depending on the design according to the embodiments herein. This is achieved with the same amount of copper in return conductor and screen as compared to conventional and existing designs of cables of the types initially mentioned. With same amount of copper it means that cross-sectional areas of the first and second conductors are equal. According to embodiments herein, cross-sectional area of the second conductor is greater than cross-sectional area of the first conductor.

In embodiments comprising the third conductor, a combined return and shielding conductor, which comprises the second and third conductor, in a two-wire system may be achieved. These embodiments were referred to as the first embodiments in section summary, i.e. the two-wire systems. Then, approximately 70% of a current, originating from a stroke of lightning, will be feed in the combined return and shielding conductor, i.e. the second and third conductor. See Figure “one core 2-wire”.

It is possible to reduce the current, occurring due to lightning strikes, or strokes of lightning, in the first conductor for powering of radio equipment. This construction gives reduced current in the first conductor and also smaller over voltage protection, such as SPD, can be used in the equipments.

Inductance of a power transmission line, i.e. the cable, in radio equipments also often have a variation of load, because the radio equipment listens and transmits. The construction according to embodiments herein also reduces the voltage ripple in the cable.

A return-conductor, such as the second conductor, has a cross section that is 100 to 500% of a cross section of a central-conductor, such as the first conductor.

A screen-conductor, such as the third conductor, has a cross section that is 100 to 500% of a cross section of a return-conductor, such as the second conductor.

The embodiments herein will lead the current from strokes of lightning to go in the outer conductor, or conductors, such as the return and shielding conductor. This reduces the current in the main conductor with about 15% to 50% for long current strikes (10/350 pulses) depending on the design with the same amount of copper in return conductor and screen as for more conventional and existing designs.

For short current strokes, such as 1/50 and 8/20 pulses, the reduction can be even up to 80% to 90%. This happens despite that total cross-sectional area of the second conductor is only slightly greater than cross-sectional area of the first conductor. In this manner, electronics in the RBS is protected again strokes of lightning. As a result, SPD with lower protection requirements may be used. In this manner, also cost of the Radio Base Station (RBS) is reduced.

A further advantage is that the low inductance that is obtained according to embodiments herein, a reduced voltage drop due to ripple-currents from load is obtained.

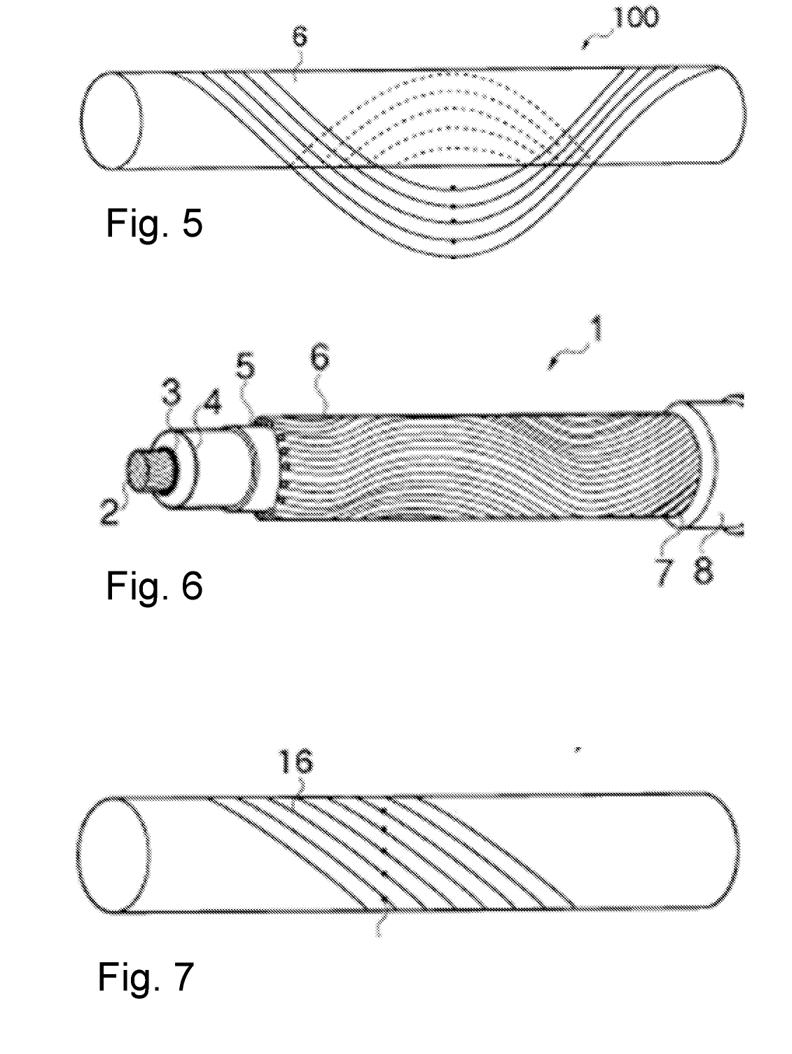

FIGS. 5-7 show an exemplifying SZ-winding of the return and/or screen conductor, i.e. the second and/or third conductor. In this manner, a large shielding area is obtained.

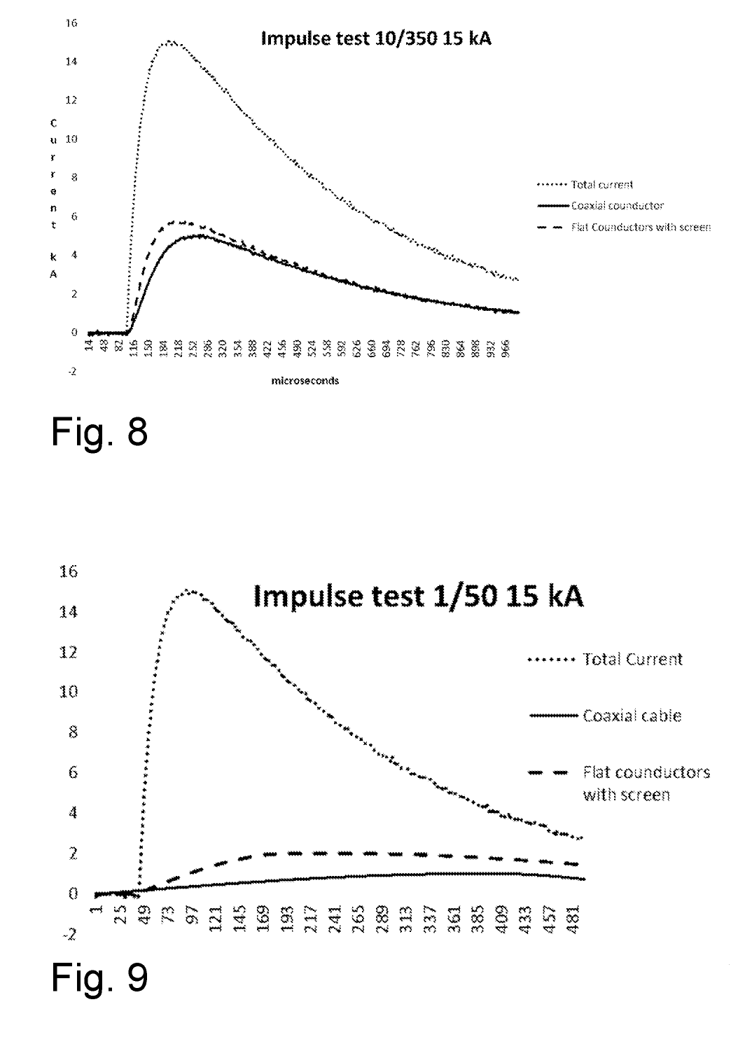

FIG. 8 is a diagram illustrating an impulse test with a pulse, having a rise time of 10 microseconds and a half-current delay of 350 microseconds, i.e. a 10/350 pulse. The pulse is measured. A 15 kA 10/350-pulse is injected to a −48 DC cable (article number TFK-421-324) and the new 2-core wire according to embodiments herein. The current in −48V conductor was around 6 kA in the measurement for the prior art cable and under 5 kA for the 2-core design with reduced copper inside according to an embodiment.

The same total area gives a lower pulse in the main (inner or first) conductor. This gives under 5 kA in the −48V conductor with a 15 kA 10/350 pulse on the cable. Compared to a cable according to article number TFL 492 32 RALFH special that gets about 6 kA in the −48V conductor with the same area on return and screen conductors.

FIG. 9 shows a 1/50 pulse where response in the coaxial cable and the flat conductor have been calculated.

With reference to FIG. 10, a cable 100 according to an embodiment is shown. This embodiment, referred to as first embodiments in the summary section, may be described as a one core 2-wire cable design.

In this example, the cable 100 comprises a main conductor 1, as an example of the first conductor, an insulting material 2, a return and ground conductor 3, as an example of the return and shielding conductor, and a jacket 4. The return and ground conductor 3 may have the shape of one elongated cylinder, having a length which is greater than, typically much greater than, a radius thereof. The elongated cylinder may have a cavity for receiving the insulation material 2 and the main conductor 1.

In this embodiment, the combined return and screen conductor 3 has a cross-sectional area that is greater than cross-sectional area of the main conductor 1 (about 150%, or sometimes greater than or equal to 150%, of main conductor).

Outer conductor lamination structure for coaxial cable used for DC electric power transmission is configured by setting gross area of outer conductor such that it is 120-500% of its cross sectional area.

In FIG. 11, a cross-sectional view of the cable 100 according to FIG. 10 is shown. In the Figure, a main conductor 1, an insulation/insulating material 2, a combined return and ground conductor 3 and a jacket 4 are shown. The cross-sectional view above is not in scale. It is merely an example, which shows the parts of an exemplifying cable of one core 2-wire type.

FIG. 12 shows frequency-response current in the first conductor (main conductor) when 15 kA total current is applied over the first and second conductor, and possibly also the third conductor. Central conductor (i.e. first conductor) of design (coaxial) has higher impedance for frequencies ≧1000 Hz than flat design. As may be seen from the Figure, the coaxial cable has a faster response than the flat conductors.

The same cross section area gives a lower pulse in the main (inner) conductor. This gives under 5 kA in the −48V conductor with a 15 kA 10/350 pulse on the cable. Compared to TFL 492 32 RALFH special that gets about 6 kA in the −48V conductor with the same area on return and screen conductors.

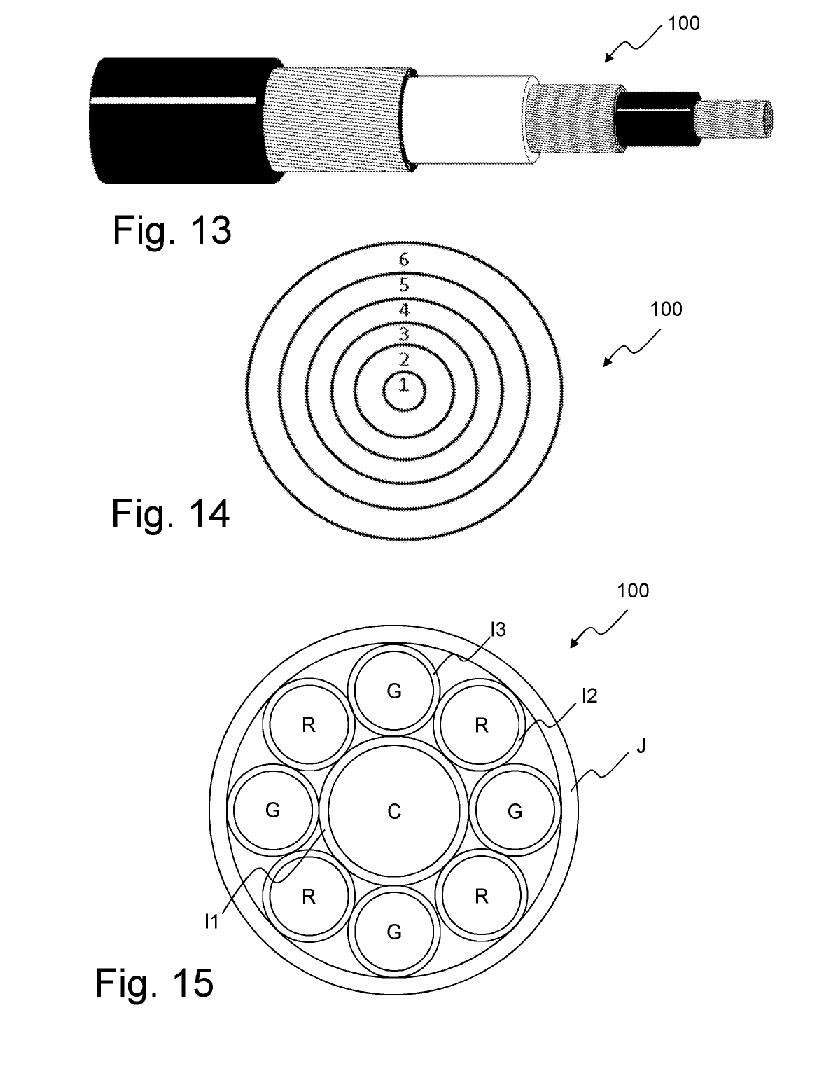

FIG. 13 illustrates a cable 100 according to embodiments herein. These embodiments may be referred to as one core 3-wire systems and relate to the second embodiments referred to in the summary section. Further details are described in conjunction with FIG. 14.

A copper area of the return and screen conductors, or shield conductor, is greater than or equal to (≧) the main conductor. In these embodiments, two concentric conducting layers, such as the second and third conductors, are arranged around the main conductor, such as the first conductor, in the middle. In some examples, this means that the second and third conductors are arranged to surround, or enclose, at least partially the first conductor.

FIG. 14 is a cross-sectional view of the cable according to FIG. 13. The cable 100 comprises a main conductor 1, an insulating material 2, a return conductor 3, an insulation for the return conductor 4, a ground conductor 5 and a jacket 6. The cross-sectional view above is not in scale. It is merely an example, which shows the parts of an exemplifying cable.

The return conductor 3 may be formed as an elongated cylinder having a cavity for receiving the insulation material 2 and the main conductor 1. The ground conductor 5 may be formed as an elongated cylinder having a cavity for receiving the insulation for the return conductor 4 and the return conductor 3. Thus Exemplifying embodiment:

| | |
|---|---|
| 1/Main Conductor | Stranded tin-plated copper wires according to |
| | IEC60228, class 5. |
| 2/Insulation main | Halogen free, flame-retardant, thermoplastic, |
| | color black. |
| 3/Return conductor | Tinplated copper wires according to |
| | IEC60228 class 5. |
| | Optional: Counter helix of Yarn may be used |
| | to lock the concentric conductor. |
| 4/Insulation return | Halogen free, flame-retardant, thermoplastic. |
| 5/Ground conductor | Annealed tinned copper wires, braid or |
| | helically applied with alternating direction |
| | (SZ). Screen area 4 mm² to 16 mm², or up to |
| | 25 mm². |
| 6/Jacket | Halogen free flame-retardant thermoplastic. |
| | Color black. |

With reference to FIGS. 15 to 19, a cable 100 is shown. The cable comprises a first conductor C enclosed by an insulting material 11, a second conductor R, and a third conductor G. The second conductor R comprises a first group of conductors, such as wires. The third conductor G comprises a second group of conductors. The conductors of the first group are arranged at the periphery of the cable 100. Similarly, the conductors of the second group are arranged at the periphery of the cable 100. At the periphery of the cable shall be understood to means distally from the geometrical longitudinal geometrical axis.

FIG. 15 illustrates an embodiment of the cable 100 with insulated return (second conductor) and ground wires (third conductor). This is a so called three-wire system. The main conductor C and return conductors R and ground conductors G are insulated separately.

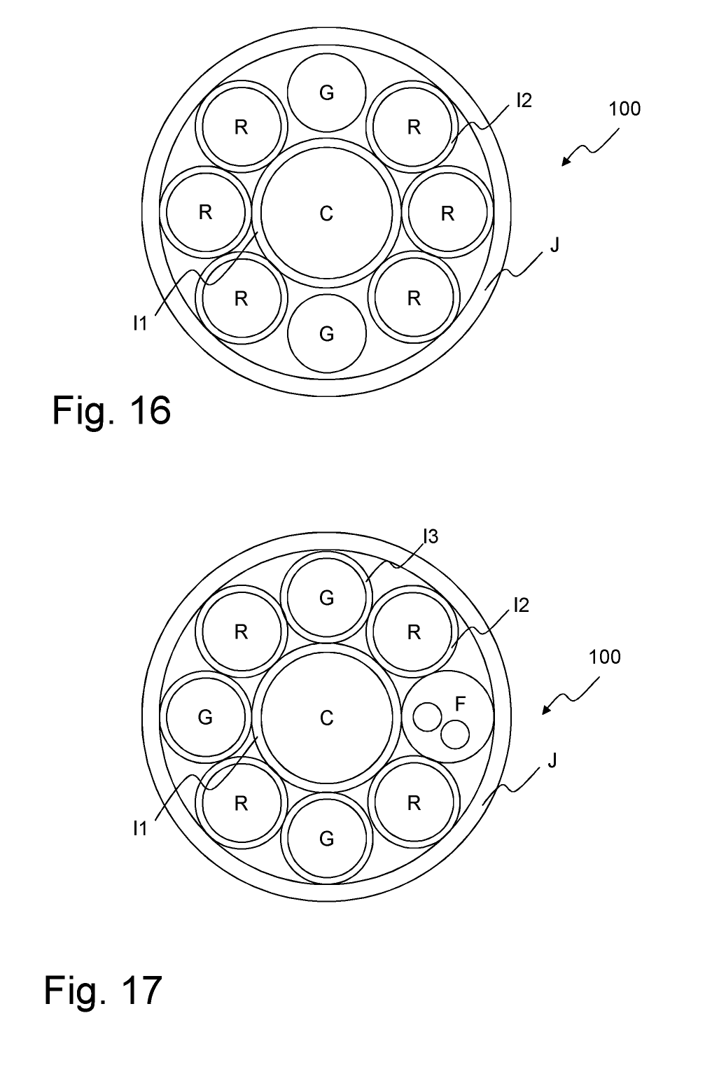

FIG. 16 illustrates an embodiment of the cable 100 with insulated 12 return and non-insulated ground wires. This is also a three-wire system. The main conductor C and return conductors R are insulated separately. As mentioned, the ground conductors G are not insulated. The main conductor(s) C is/are insulated 11.

FIG. 17 illustrates an embodiment of the cable 100 with insulated return and ground wires and an optical fiber for the RRU signals. This is also a three-wire system. The main conductor C and return conductors R and ground conductors are insulated I1, I2, and I3 separately. The cable also has a fiber cable F in the screen for the signals to the remote radio units (RRU).

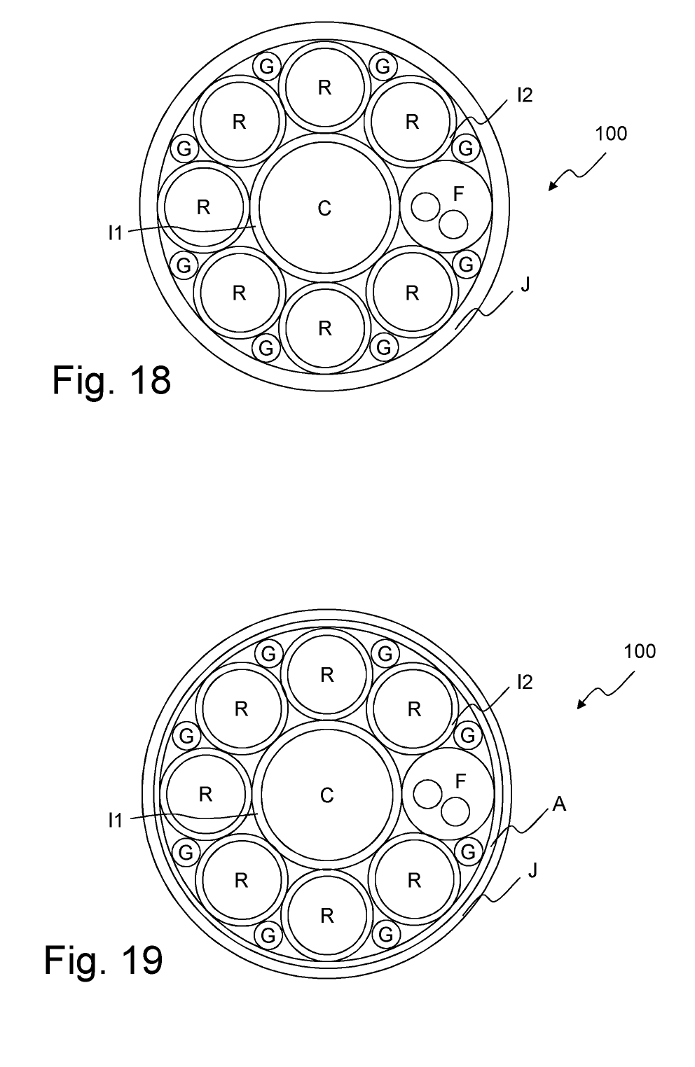

FIG. 18 illustrates an embodiment of the cable 100 with insulated return and non-insulated ground wires and an optical fiber for the RRU signals. This is also a three-wire system. The main conductor (C) and return conductors (R) are insulated separately. As mentioned, the ground conductors (G) are non-insulated. The cable also has a fiber cable (F) in the screen for the signals to the remote radio units (RRU).

FIG. 19 illustrates an embodiment according with coaxial design in which insulated return and ground wires and an optical fiber for the RRU signals are comprised in the cable 100. A metallic foil A, preferably an aluminum or copper foil, is wrapped or longitudinally laid around the conductors for even better mechanical and electrical characteristics. This is also a three-wire system. The ground wires can also have contact with the metallic foil A under the jacket.

Now returning to FIG. 16, which may form basis for a further embodiment, in which a metallic foil, similarly to as in FIG. 19, encloses the return and ground conductors R, G. The metallic foil is located between the jacket J and the return and ground conductors R, G.

With reference to FIGS. 18 and 19, the second group of conductors is arranged for shielding of the first conductor C and the second conductor R. This means that the second group of conductors at least partially encloses the first group of conductors. Moreover, the second group of conductors is located peripherally of the first group of conductors with respect to the longitudinal axis of the cable 100.

According to further embodiments, there is provided so called multi-power cables and Hybrid cables as described in the following. In these embodiments, two or more cables according for example the embodiments described with reference to FIGS. 10-19 are grouped, or arranged, within a cover E. The cover E, which can be exemplified by a jacket or an envelope, encloses said two or more cables 100.

A multi-power cable is a cable with 2 or more power conductors, such as the first conductor, and optionally one or more fibers

A hybrid cable is a cable with one or more power conductor and fibers

FIG. 20 illustrates an exemplifying embodiment comprising TFL 252 8306 3 x coaxial power cables. The figure is an exploded view of such coaxial power cable.

The main purpose is to take several coax power cables under one jacket for easier installation in a telecom tower. The coax power cables can easily be separated and connected to different RRU in the telecom tower. In the separating point a shrink tube with one big hole in one side and 2 to six holes for the power cables and eventually also hole/holes for optical cable/cables at the other side to protect the splitting up point.

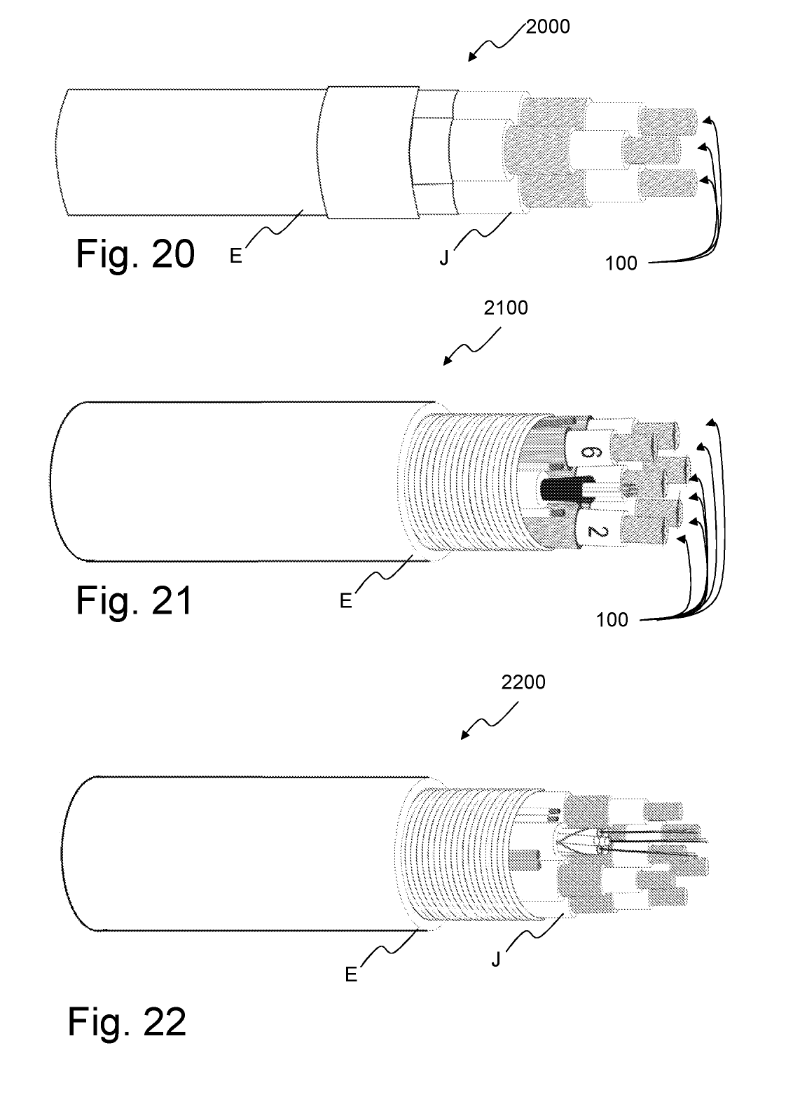

Hybrid cables are illustrated in FIGS. 21 and 22.

FIG. 21 illustrates an exemplifying hybrid Cable with the return conductors in contact with screen foil. This is an arrangement of cables according to the 2 wire system. The arrangement comprises 3 to 6 exemplifying coaxial power cables according to embodiments herein. The cable also includes an optical fiber cable and signal wires.

FIG. 22 illustrates a further exemplifying hybrid cable with the return conductors with their own jacket. The cables included in the hybrid cable are of type 3 wire system. The hybrid cable, as an example of the cable arrangement, includes 3 or 6 coaxial power cables, normally 3 to 6 power cables. Often an optical fiber cable and signal wires are included in the hybrid cable.

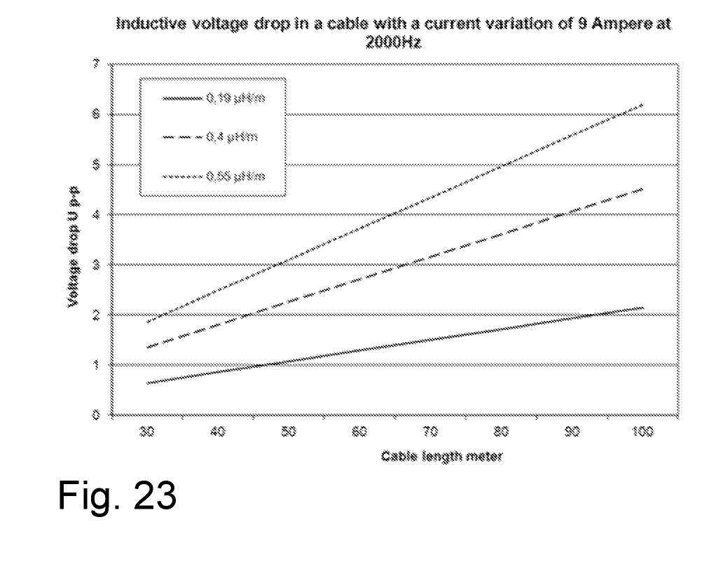

Returning to the discussion about ripple current, it can be seen from FIG. 23 that the cable according to embodiments has both low inductance to give low voltage variation due to the ripple currents and high impedance at main conductor to handle strokes of lightning. Thus, impedance seen by the ripple current in the return and shielding conductor is relatively low.

In FIG. 23, three graphs shows voltage drop as a function of cable length for three different inductances of cable. The difference in inductance depends on the design of the cable. Voltage drop (U) peak-to-peak (p-p) at the vertical axis. As can be seen from the Figure, the smaller the inductance of the cable is, the less voltage variation due to load variation.

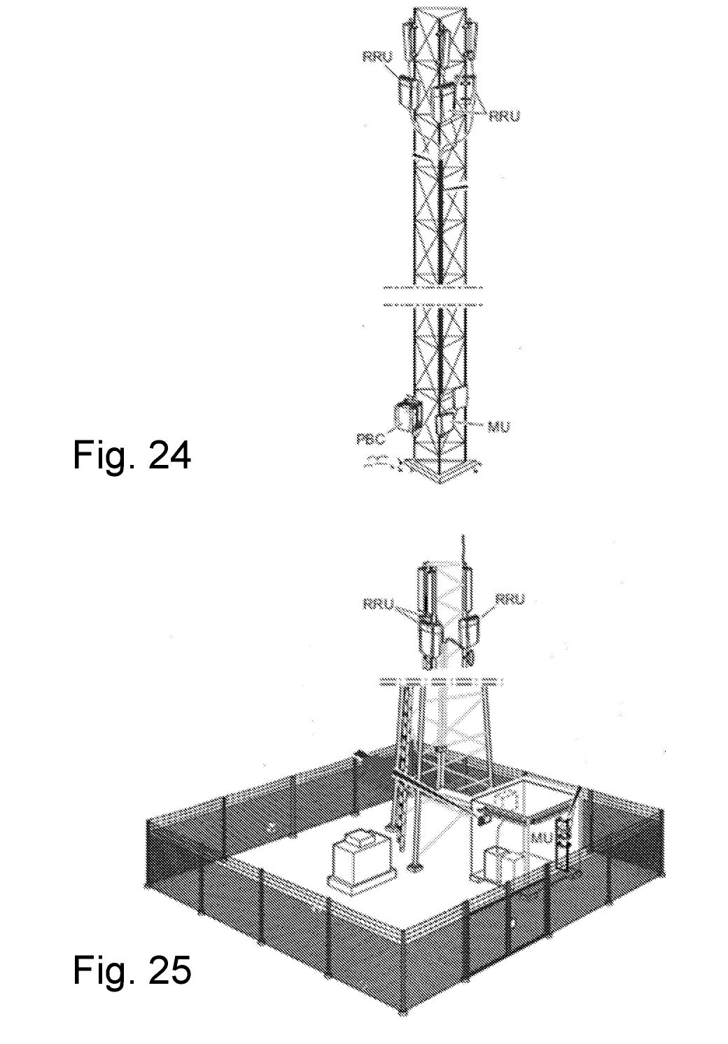

In FIGS. 24 to 27, a few exemplifying masts for carrying radio equipment are shown.

FIG. 24 illustrates an exemplifying outdoor site, a shelter and cabinets

FIG. 25 illustrates an exemplifying outdoor site, a shelter and cabinets

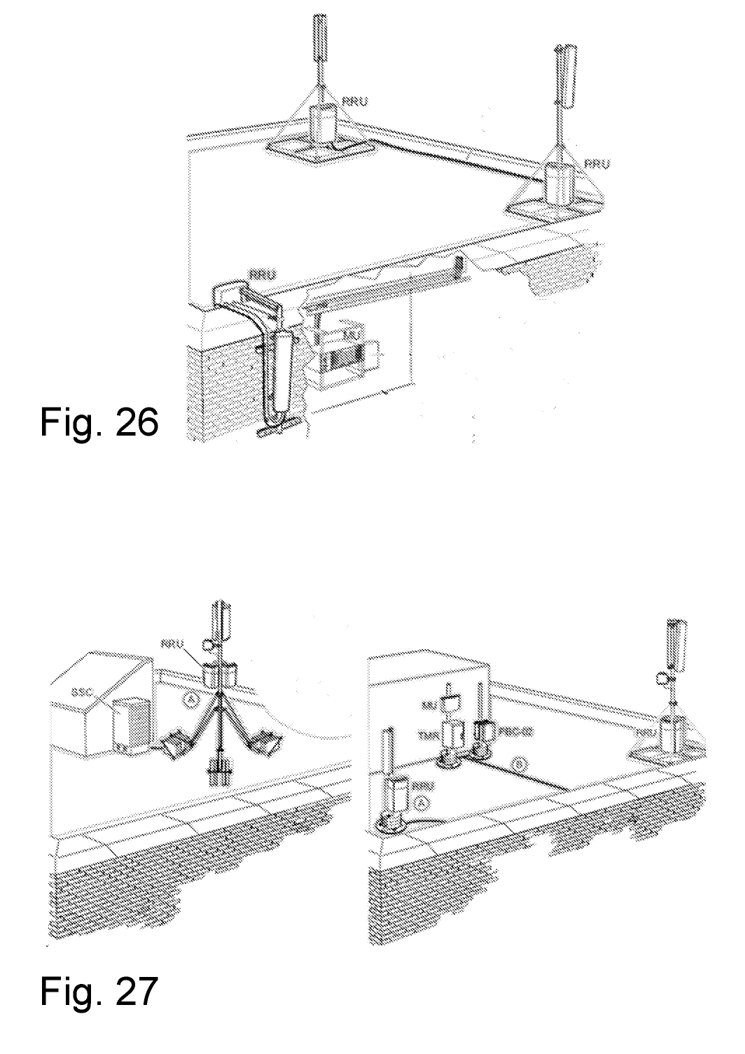

FIG. 26 illustrates an exemplifying combined rooftop and indoor Radio Base Station (RBS) site.

FIG. 27 illustrates an exemplifying combined rooftop and outdoor site.

As used herein, the expressions “insulating”, “insulation” have been used to express electrical insulation between two or more conductors, wires or the like.

Even though embodiments of the various aspects have been described, many different alterations, modifications and the like thereof will become apparent for those skilled in the art. The described embodiments are therefore not intended to limit the scope of the present disclosure.

1. A cable for powering of radio equipment mounted on a mast for carrying the radio equipment, the cable comprising:
a first conductor for feeding a current to the radio equipment,
a return and shielding conductor for feeding a return current from the radio equipment and for shielding of the first conductor, and
an insulating material disposed between the first conductor and the return and shielding conductor, wherein the first conductor is at least partially enclosed by the insulating material,
wherein a first cross-sectional area of the first conductor is less than a second cross-sectional area of the return and shielding conductor.

2. The cable according to claim 1, wherein the return and shielding conductor at least partially encloses the first conductor and the insulating material.

3. The cable according to claim 1, wherein the first conductor comprises a first set of conductors and/or the return and shielding conductor comprises a second set of conductors.

4. The cable according to claim 1, wherein the first conductor has the shape of an elongated cylinder, whose length is greater than a radius thereof.

5. The cable according to claim 1, wherein the return and shielding conductor has the shape of one or more elongated cylinders, each of which having a length which is greater than a radius thereof.

6. The cable according to claim 1, wherein the return and shielding conductor is enclosed by an insulating layer.

7. The cable according to claim 1, wherein the return and shielding conductor comprises:
a second conductor for feeding of the return current; and
a third conductor for shielding of the first conductor.

8. The cable according to claim 7, wherein the second conductor comprises a first group of conductors for return current.

9. The cable according to claim 8, wherein the conductors of the first group are arranged at the periphery of the cable.

10. The cable according to claim 8, wherein one or more of the conductors of the first group are enclosed by a respective first insulating layer.

11. The cable according to claim 7, wherein the third conductor comprises a second group of conductors for shielding of the first conductor and/or the second conductor.

12. The cable according to claim 11, wherein the conductors of the second group are arranged at the periphery of the cable.

13. The cable according to claim 11, wherein one or more of the conductors of the second group may be enclosed by a respective second insulating layer.

14. The cable according to claim 7, wherein at least one of the second and third conductors is located such as to at least partially enclose the first conductor.

15. The cable according to claim 14, wherein the cable has a longitudinal geometrical axis, wherein at least one of the second conductor and the third conductor is located to at least partially enclose the first conductor, wherein at least one of the second and third conductors is spaced apart from the first conductor by means of the insulating material.

16. The cable according to claim 7, wherein the second conductor is formed as an elongated cylinder having a cavity for receiving the insulating material and/or the first conductor, wherein the third conductor is formed as an elongated cylinder having a cavity for receiving the insulating layer and/or the second conductor.

17. The cable according to claim 1, wherein the cable is enclosed with at least one other cable in a jacket.
